(19) United States
(12) Patent Application Publication
(10) Pub. No.: US 2015/0336829 A1
(43) Pub. Date: Nov. 26, 2015

(54) WATER TREATMENT SYSTEM

(71) Applicant: Hitachi, Ltd., Tokyo (JP)

(72) Inventors: Akira MOCHIZUKI, Tokyo (JP); Hisashi ISOGAMI, Tokyo (JP); Satoshi MIYABAYASHI, Tokyo (JP)

(21) Appl. No.: 14/410,396

(22) PCT Filed: Jun. 21, 2013
(86) PCT No.: PCT/JP2013/067062

§ 371 Date: Dec. 22, 2014

(30) Foreign Application Priority Data
Jun. 22, 2012 (JP) 2012-141420

(51) Int. Cl. C02F 9/00; C02F 1/00; C02F 1/04; C02F 1/28

(52) U.S. Cl. CPC C02F 9/00; C02F 1/28; C02F 1/281; C02F 1/283; C02F 1/008; C02F 1/048; C02F 2103/10

(57) ABSTRACT

Provided is a water treatment system which realizes reduction of the environmental load and energy saving. The system includes: an adsorption unit (10) provided with an adsorbent (11) of adsorbing a target in an aqueous solution which is supplied thereto; an separation tank (20) supplied with the target removed from the adsorbent (11) by a medium contacting thereto, water and the medium after contacting, and separating the medium from the mixture of the supplied water, medium and target; a circulation passage connecting the adsorption unit (10) with the separation tank (20), whereby a circulation unit circulates the medium between the adsorption unit (10) and the separation tank (20) via the passage; and an operation control unit 50 controlling a flow of the medium in accordance with a change in an amount of the water removed from the adsorbent (11) and supplied to the separation tank (20).

### BACKGROUND ART

Waste water and treated water of oil sands from, for example, oil mines, petroleum chemistry plants, and industrial plants contain polluted substances, such as metal elements (for example, in a form of simple substance, compound or ion) and water-soluble organic substances. Therefore, from the viewpoint of reducing an environmental load, when such water (or waste water) is discharged to the outside (e.g., river and ocean), the metal elements and water-soluble organic substances, etc., in the waste water are removed and then discharge as purified water. Herein, the water-soluble organic substances include, for example, benzene, phenol, and naphthenic acid or the like.

A technique of removing the polluted substances includes, for example, a magnetic separation technique utilizing a magnetite. However, depending on a kind and a size of such polluted substances, there are some cases in which those polluted substances are not completely removed. In such a case, after the polluted substances are removed from the waste water to a certain degree through the magnetic separation technique, another treatment may be further performed for the waste water after the above mentioned treatment.

For example, after waste water is treated by the magnetic separation technique, the waste water thus treated may have contact with, for example, activated charcoal, zeolite, and aluminum oxide (hereinafter, simply referred to as “activated charcoal, etc.,”). Accordingly, the polluted substances remaining in the waste water thus treated come to be adsorbed by the activated charcoal, etc., allowing the concentration of the polluted substances in the water to be reduced. Then, the water thus treated is discharged into the outside. Note another treatment is performed on the activated charcoal, etc., which adsorbs the polluted substances, etc., such that the adsorbed polluted substances are removed therefrom. Accordingly, the activated charcoal, etc., recovers a function for adsorbing polluted substances again. Such a treatment performed on the activated charcoal, etc., is referred to as “recycling” in this specification.

A recycling technique of the activated charcoal, etc., includes, for example, a method for exposing the activated charcoal, etc., with high-temperature steam, to have the adsorbed polluted substances vaporized so as to discharge the polluted substances thus vaporized. Alternatively, another exemplary technique includes a method for contacting the activated charcoal, etc., with an electrolyte solution containing, for example, sodium chloride to desorb the adsorbed polluted substances. Herein, the addition of the electrolyte to the polluted substances thus desorbed may decompose the water-soluble organic substances, that is, polluted substances. Further, the activated charcoal, etc., used for the above mentioned treatment may be replaced by new activated charcoal, etc.

Moreover, it is known that a different recycling technique of the activated charcoal, etc is described in Patent Literature 1. More specifically, Patent Literature 1 discloses a technique for removing water from a solid material containing water by using a liquefied substance. This technique comprises the steps of: contacting a solid material containing water with a liquefied substance that turns to gas at 25° C. and 1 atm. (hereinafter, referred to as a substance D); dissolving water contained in the solid material into the liquefied substance D; and obtaining the liquefied substance D with the high water content, thereby to remove the water contained in the solid material. Then, the technique further comprises the steps of: vaporizing the substance D in the obtained liquefied substance D with the high water content; separating the vaporized substance D from the water; collecting the gas of the separated substance D; liquefying the substance D by pressurizing, cooling or performing the combination to, the collected gas, so as to obtain a liquid thereof; and reusing the liquid again for removing the water contained in the above mentioned solid material. Further, the patent document discloses a technique for recovering the energy generated at the external system during the vaporization process, and utilizing the energy thus recovered for the liquefying process as a part of the power used in the liquefying process.

### PRIOR ART REFERENCE

### Patent Literature

Patent Literature 1: Japan Patent No. 4291772

### SUMMARY OF THE INVENTION

### Problems to be Solved by the Invention

However, the above mentioned recycling techniques have a drawback from a viewpoint of zero emission and energy saving. That is, in order to generate high-temperature steam, electrical power or thermal power is required, resulting in a drawback from the standpoint of the energy saving. Further, when the technique has the step of letting the electrolyte solution flow, a large amount of the electrolyte solution is needed for the flow in order to remove the polluted substances. This step may produce an additional amount of the waste water containing polluted substances. Moreover, according to the above mentioned recycling techniques, there is no index clearly indicating the endpoint at which the recycling process is completed. This may force the recycling process to be excessively repeated in some cases. Furthermore, when the activated charcoal, etc., is replaced by new one, the used activated charcoal, etc., may be removed to the external system, resulting in a drawback from the standpoint of a zero emission procedure.

Hence, the inventors of the present invention have investigated a method to be replaced by the conventional recycling techniques. As a result, the inventors of the present invention have found that in the adsorption treatment of polluted substances by the activated charcoal, etc., polluted substances in absence of water are hardly adsorbed by the activated charcoal, etc., while a waste liquid containing such polluted substances is likely to be adsorbed by the activated charcoal, etc. Further, the inventors of the present invention have found that in order to recycle the activated charcoal, etc., it is effective to remove water in the waste liquid that contains the polluted substances and has been adsorbed by the activated charcoal, etc. Those findings enable the polluted substances adsorbed by the activated charcoal, etc., to be removed together with water, resulting in the recycling of the activated charcoal, etc.

According to the technology disclosed in Patent Literature 1, coals containing water are dehydrated by using dimethyl ether. Herein, it should be noted that such coals are continuously dehydrated further even until the coals turn to contain no water. Accordingly, the above mentioned dehydration process may be continuously performed, regardless of the necessity of further performing the dehydration operation, for example, in a case that no further dehydration is needed because of the little water content in the treated coals. When the activated charcoal, etc., is recycled through the technology disclosed in Patent Literature 1, the technology disclosed in the patent document still has room for further improvement from a viewpoint of energy saving.

The present invention has been made in view of the above mentioned drawbacks. Here, an object of the present invention is to provide a water treatment system that realizes higher energy saving while reducing an environmental load.

### Means for Solving the Problems

The present inventors have significantly investigated a water treatment system so as to solve the above mentioned drawbacks. Accordingly, the present inventors have found that the above mentioned drawbacks are solved by a method for controlling a medium flow corresponding to a change in the water amount supplied to a separation tank (or separation unit). Herein, the method comprises the step of circulating the medium to successively contact with the adsorbent.

### Effect of the Invention

According to the present invention, a water treatment system is provided, which realizes further energy saving while reducing an environmental load.

### BRIEF DESCRIPTION OF THE DRAWINGS

FIG. 1 is a schematic diagram illustrating a water treatment system in a first embodiment.

FIG. 2 is a graphic diagram illustrating a change in the water amount supplied to a separation tank 20 per an elapsed time after the start of the recycling process.

FIG. 3 is a schematic diagram illustrating a water treatment system in a second embodiment.

FIG. 4 is a schematic diagram illustrating a water treatment system in a third embodiment.

FIG. 5 is a schematic diagram illustrating a water treatment system in a fourth embodiment.

FIG. 6 is a schematic diagram illustrating a water treatment system in a fifth embodiment.

FIG. 7 is a schematic diagram illustrating a water purification system including the water treatment system of the first embodiment.

FIG. 8 is a schematic diagram illustrating a water purification system including the water treatment system of the second embodiment.

### EMBODIMENTS FOR CARRYING OUT THE INVENTION

Hereinafter, embodiments for carrying out the present invention (or present embodiments) will be explained in detail referring to the accompanying drawings. Herein, it should be noted that the present embodiments are not limited to the following descriptions as described below.

### 1. First Embodiment

[Structure]

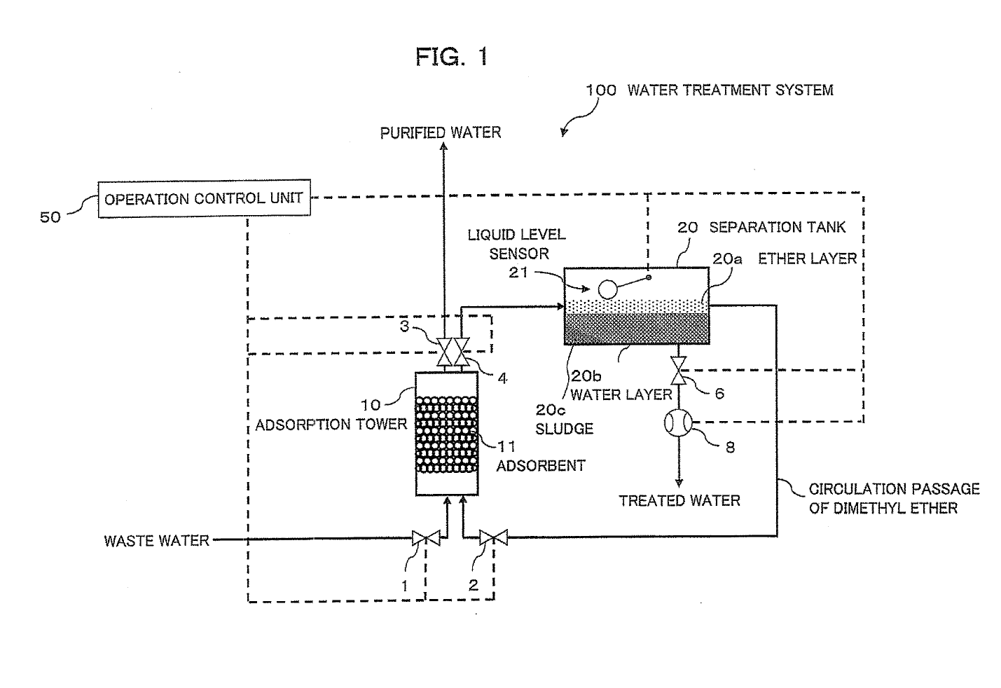

FIG. 1 is a schematic diagram illustrating a water treatment system 100 in a first embodiment. The water treatment system 100 includes an adsorption tower 10, a separation tank 20, piping for interconnecting the adsorption tower 10 and the separation tank 20 together, and piping through which waste water, purified water and treated water flow (in FIG. 1, the piping is indicated by thick lines with arrows in order to simplify the illustration, and the direction of the arrow indicates the flow direction), valves 1, 2, 3, and 4 provided at each piping, and an operation control unit 50 that controls respective units of the water treatment system 100. The adsorption tower 10 has an adsorbent 11 filled therein to adsorb polluted substances contained in the waste water. Further, dashed lines indicate electrical signal lines connected in a wired or wireless manner.

A liquid of dimethyl ether (or medium) is circulated between the adsorption tower 10 and the separation tank 20, and thus a circulation passage of dimethyl ether is formed therebetween. Dimethyl ether is circulated by an unillustrated circulation pump, etc. That is, as illustrated in FIG. 1, the circulation passage of dimethyl ether (or circulation passage) connects the adsorption tower 10 (or adsorption unit) with the separation tank 20 (or separation unit). Herein, the dimethyl ether (or medium) to be in contact with the adsorbent 11 is circulated between the adsorption tower 10 (or adsorption unit) and the separation tank 20 (or separation unit) by the circulation pump (or circulation unit).

A liquid level sensor 21 is provided in the separation tank 20, and thus the liquid level (or total height of an ether layer 20a and a water layer 20b) in the separation tank 20 is measurable. That is, the liquid level sensor 21 is to measure the liquid level of the liquid (or ether layer 20a and water layer 20b) reserved in the separation tank 20. In the water treatment system 100, recycling of the adsorbent 11 is performed based on this liquid level. This will be discussed later in detail together with an explanation for “recycling control of adsorbent 11”.

The adsorption tower 10 adsorbs polluted substances contained in the waste water, and discharges the water to the outside as purified water. The adsorption tower 10 is filled with the adsorbent 11 (e.g., activated charcoal, aluminum oxide, or zeolite) that adsorbs polluted substances contained in the waste water. That is, waste water (or aqueous solution) is supplied to the adsorption tower 10 (or adsorption unit). Herein, the adsorption tower 10 is provided with the adsorbent 11 that adsorbs polluted substances (or targets) in the waste water (or aqueous solution) thus supplied.

The waste water flows through the inside of the adsorption tower 10 from the lower part thereof with the valves 1 and 3 being opened and the valves 2 and 4 being closed. The waste water supplied to the adsorption tower 10 contacts the adsorbent 11, and thus polluted substances contained in the waste water are adsorbed by the adsorbent 11. Then, the waste water (i.e., purified water) of which impurities have been adsorbed and thus removed is discharged to the outside through the opened valve 3.

Next, in the adsorption tower 10, the dimethyl ether flows from the lower part of the tower 10 to recycle the adsorbent 11. More specifically, dimethyl ether flowing through the inside of the adsorption tower 10 and contacting the adsorbent 11 removes polluted substances dissolved in water adsorbed by the adsorbent 11 together with water. Then, dimethyl ether, polluted substances and water, which have been released from the adsorbent 11, are thus supplied to the separation tank 20.

Next, the separation tank 20 (or separation unit) separates dimethyl ether, the polluted substances and water thus supplied from the adsorption tower 10, into the ether layer 20a (or upper layer) containing dimethyl ether, and the water layer 20b (or lower layer) containing the polluted substances and water. A mixture thus supplied from the adsorption tower 10 is accumulated in the separation tank 20. Accordingly, this allows the mixture to be separated into the ether layer 20a and the water layer 20b. That is, the polluted substances (or targets) and water both of which have been removed by having the adsorbent 11 contact with dimethyl ether (or medium), and dimethyl ether (or medium) which has contacted with the adsorbent 11, are supplied to the separation tank 20. Then, dimethyl ether (or medium) is selectively separated from the mixture of the supplied water, dimethyl ether (or medium) and polluted substances (or targets).

Note that solid materials discharged from the adsorption tower 10 to be undissolved in both of water and dimethyl ether, are thus deposited on the bottom of the separation tank 20 as sludge 20c. The sludge 20c is periodically discharged to the outside.

Here, the ether layer 20a in the separation tank 20 is to be returned to the adsorption tower 10 through the above-explained circulation passage of dimethyl ether. Next, the returned dimethyl ether is utilized for recycling the adsorbent 11 again. This recycle of dimethyl ether allows a total amount of dimethyl ether discharged to the outside to be decreased.

The water layer 20b in the separation tank 20 contains polluted substances (that is, heavy metal ions, water-soluble organic substances, etc.) removed from the adsorbent 11. Hence, the water layer 20b is to be discharged as treated water through a valve 6 and a flow volume sensor 8, thereby to be treated by an unillustrated treatment device. The water amount supplied from the adsorption tower 10 is generally little. Accordingly, the water amount layer 20b is little, allowing the amount of the treated water supplied to the unillustrated treatment device to be reduced. That is, the polluted substances released from the adsorbent 11 are to be collected and treated in a condensed state.

The operation control unit 50 controls the circulation pump that circulates dimethyl ether based on the liquid level measured by the liquid level sensor 21. In other words, the operation control unit 50 controls the flow of dimethyl ether (or medium) in accordance with a change in the water amount supplied to the separation tank 20. Herein, the change in the water amount is caused by having the dimethyl ether (or medium) circulate and successively contact with the adsorbent 11. The detail of the control by the operation control unit 50 will be described hereinafter.

The operation control unit 50 also controls, for example, the valves 1, 2, 3, and 4, and a pump (unillustrated) that supplies the waste water to the adsorption tower 10. Further, the operation control unit 50 adjusts the opening degree of the valve 6 in accordance with the flow volume measured by the flow volume sensor 8.

The operation control unit 50 includes, for example, a CPU (or Central Processing Unit), a RAM (or Random Access Memory), a ROM (or Read Only Memory), an I/F (or interface), an HDD (or Hard Disk Drive), a sensor circuit and a control circuit (or both unillustrated). The above mentioned controlling operations are realized by the CPU executing a predetermined control program stored in the ROM.

[Recycling Control of Adsorbent 11]

Next, a control method for recycling the adsorbent 11 in the water treatment system 10 will be described. The operation control unit 50 executes the following control operations.

As explained above, dimethyl ether is successively circulated between the adsorption tower 10 and the separation tank 20. Here, dimethyl ether contacts with the adsorbent 11 thereby to recycle the adsorbent 11.

In this circulation, when all the polluted substances adsorbed by the adsorbent 11 are released and transferred to the separation tank 20, it becomes unnecessary to further recycling the adsorbent 11. Accordingly, from a viewpoint of energy saving, the recycling control operations are set to be terminated in the water treatment system 100, after the polluted substances adsorbed by the adsorbent 11 have been released and transferred to the separation tank 20,

Generally, waste water to be supplied to the adsorption tower 10 is filtrated by a filter, etc., in advance. Accordingly, such waste water to be treated hardly contains large sized polluted substances (or solid materials). Hereby, a major part of the polluted substances (more specifically, heavy metal ions and water-soluble organic substance, etc.) is dissolved in the waste water. Hence, the polluted substances are dissolved in water and then adsorbed by the adsorbent 11. As a result, when the adsorbent 11 is recycled using dimethyl ether, the polluted substances are released and transferred (or collected) together with water. Therefore, the more the polluted substances adsorbed by the adsorbent 11 are collected in the separation tank 20, the more the amount of the water layer 20b in the separation tank 20 increases.

When the recycling process of the adsorbent 11 by dimethyl ether is completed, the adsorbent 11 turns to not adsorb any polluted substances. At that state, only dimethyl ether is circulated and the water amount layer 20b in the separation tank 20 becomes unchanged. If the water amount layer 20b becomes unchanged, the liquid level in the separation tank 20 measured by the liquid level sensor 21 becomes also unchanged. As described above, the control operation is performed such that that recycling of the adsorbent 11 is terminated in the water treatment system 100, when a change in the liquid level becomes substantially zero.

As explained above, in the water treatment system 100, a change in the water amount supplied to the separation tank 20 is calculated based on the liquid level measured by the liquid level sensor 21. Herein, since the amount of dimethyl ether to be circulated is constant, the level of the ether layer 20a becomes substantially constant. Accordingly, the liquid level measured by the liquid level sensor 21 changes in association with a change in the water amount supplied to the separation tank 20. Note the change in the water amount is caused by the circulation of dimethyl ether (or medium) successively contacting with the adsorbent 11. This allows the change in the water amount supplied to the separation tank 20 to be calculated based on the liquid level measured by the liquid level sensor 21.

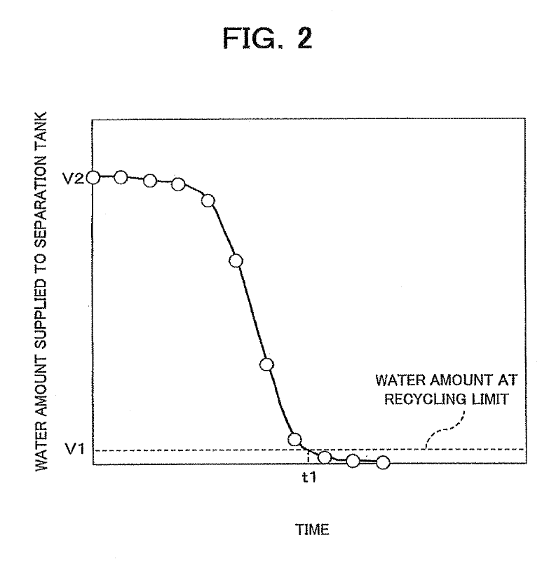

FIG. 2 is a graphic diagram illustrating a change in the water amount supplied to the separation tank 20 per an elapsed time. The horizontal axis indicates an elapsed time after the start of recycling, and the vertical axis indicates the water amount supplied to the separation tank 20 at the time elapsed after the start of recycling (i.e., the water amount collected from the adsorption tower 10).

The water amount collected from the adsorption tower 10 becomes maximum (V2) right after the recycling of the adsorbent 11 is started via the contact with dimethyl ether. Since water is continuously supplied at the flow volume of substantially V2 for a while after the start of recycling, a change in the liquid level increases. Then, the amount of collected water as time passes gradually decreases, and a change in the liquid level gradually decreases along with the decrease in the collected water amount. In this embodiment, when a time t1 elapses and the amount of supplied water becomes V1 (or water amount at the recycling limit), circulation of dimethyl ether is terminated, whereby the recycling process is terminated. This terminated time is set at the time when the change in the liquid level becomes equal to or smaller than a predetermined value. Note the circulation process is continued for a while after the termination of the circulation, thereby to completely remove the polluted substances together with water adsorbed by the adsorbent 11.

In other words, when the valve 6 is closed, a change in the liquid level measured by the liquid level sensor 21 is relatively large right after the start of the recycling process. Thereafter, since the amount of collected water gradually decreases, a change in the liquid level becomes small. Then, when a change in the liquid level measured by the liquid level sensor 21 (or a change per a unit time) becomes smaller than a predetermined degree, the circulation of dimethyl ether is terminated, whereby the recycling process is also terminated. After that, as explained above, the circulation is continued for a while after the circulation has been terminated, thereby to completely remove the polluted substances. Note the allowable range of the change in the liquid level may be set via performing experiments or a test operation, etc. For example, if a change in the liquid level becomes equal to or smaller than the change level when the water amount supplied to the separation tank 20 is V1, the control operation may be terminated.

Next, the mixture of the polluted substances and water (or water layer 20b) removed from the adsorbent 11 is discharged to the outside through the valve 6. The flow volume sensor 8 measures the flow volume of the mixture (i.e., the water layer 20b) of the water and the polluted substances (or liquid) discharged when the water and the polluted substances (or liquid) stored in the separation tank 8 are discharged to the outside. After that, the opening degree of the valve 6 is adjusted appropriately based on the discharging flow volume measured by the flow volume sensor 8 such that no ether layer 20a in the separation tank 20 is discharged to the outside. Accordingly, the water layer 20b is discharged to the outside as treated water.

### Advantages

According to the water treatment system 100 of this embodiment, the recycling process of the adsorbent 11 is controlled based on the change in the liquid level (in other words, the change in the water amount) in the separation tank 20. The execution of such recycling control suppresses unnecessary recycling regardless of the absence of the adsorbed substances on the adsorbent 11, allowing the energy saving to be accomplished. Further, the recycling of the adsorbent 11 is controlled based on the change in the liquid level in the separation tank 20, whereby the adsorbent 11 may be recycled based on a simple index.

Further, the circulation of dimethyl ether utilized for recycling the adsorbent 11 enables a discharging amount thereof to the outside to become extremely small. Accordingly, the water treatment system 100 of this embodiment is suitable for accomplishing zero emission which is desirable in recent years from the viewpoint of decrease in the environmental load.

Moreover, since the adsorbent 11 adsorbs heavy metal ions via a small amount of the ionic aqueous solution, the heavy metal ions are collected in the separation tank 20 in an aqueous solution state. Hence, the heavy metal ions collected from the adsorbent 11 are collected in the separation tank 20 in a condensed manner. Accordingly, the volume of the treated water subjected to a removal of heavy metals can be reduced, allowing the removal efficiency of heavy metals in the treated water by heavy metal removing equipment (not shown) to be improved. Furthermore, this also allows the removing equipment to be downsized.

Further, since heavy metal elements can be obtained in a condensed manner, according to the water treatment system 100, so-called rare metals, such as palladium, cobalt, and platinum, can be efficiently collected from waste water at a low cost. As explained above, the water treatment system 100 of this embodiment is suitable for not only purification of waste water but also the application for, for example, collecting metal elements.

### 2. Second Embodiment

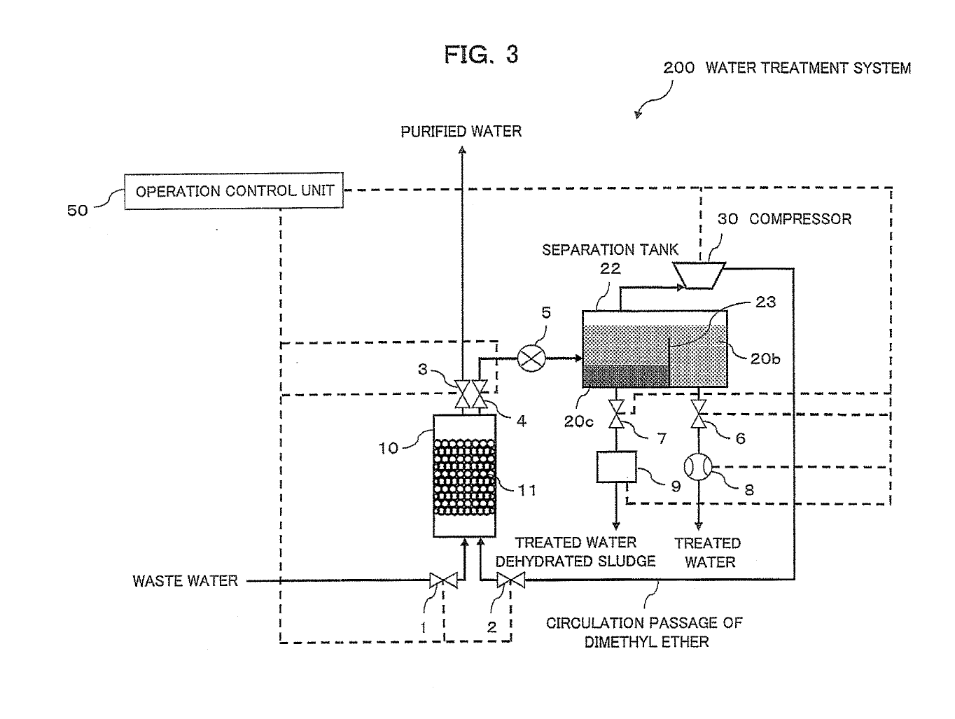

Next, with reference to FIG. 3, an explanation will be given of a water treatment system 200 in a second embodiment. Note the same component as that of the water treatment system 100 will be denoted by the same reference numeral, and the detailed explanation thereof will be omitted. The water treatment system 200 has the same basic structure as that of the water treatment system 100. Therefore, in the following explanation, different features from the above-explained water treatment system 100 will be mainly explained.

FIG. 3 is a schematic diagram illustrating the water treatment system 200 in the second embodiment. The water treatment system 100 in FIG. 1 is provided with the separation tank 20 and the liquid level sensor 21, but instead of those components, a scattering valve 5, another separation tank 22, and a compressor 30, etc., are provided.

The scattering valve 5 (or vaporization unit) is provided in the halfway of the circulation passage of dimethyl ether (or circulation passage) from the adsorption tower 10 (adsorption unit) to the separation tank 20, and vaporizes flowing dimethyl ether (or medium). Further, the separation tank 22 (or separation unit) is a three-layer separation tank that separates the target into three layers: an unillustrated layer (gas layer) containing dimethyl ether; the water layer 20b (or liquid layer); and a sludge 20c (solid layer). The compressor 30 (or liquefying unit) is provided in the halfway of the circulation passage of dimethyl ether (or circulation passage) from the separation tank 20 to the adsorption tower 10 (or adsorption unit), and liquefies flowing dimethyl ether (or medium).

As different from the water treatment system 100 illustrated in FIG. 1, there is no ether layer 20a that is a layer of liquid. This is because the circulating dimethyl ether is transformed into gas in the separation tank 22 according to the water treatment system 200, which will be discussed in detail hereinafter.

Dimethyl ether circulates the circulation passage of dimethyl ether, whereby the adsorbent 11 is to be recycled. Hereby, polluted substances adsorbed by the adsorbent 11 are supplied to the separation tank 22 together with dimethyl ether and water. A mixture of the polluted substances, water and dimethyl ether to be supplied to the separation tank 22 is scattered by the scattering valve 5 (including orifices, etc.) provided between the adsorption tower 10 and the separation tank 22, and then supplied to the separation tank 22.

When the mixture of the polluted substances, water, and dimethyl ether is scattered, dimethyl ether is firstly vaporized due to the difference of the boiling points. Accordingly, by scattering the mixture of those substances before supplied to the separation tank 22, such a mixture can be separated into vapor of dimethyl ether, a liquid of polluted substances and water. Then, dimethyl ether changed to vapor is discharged to the external system through the upper portion of the separation tank 22, compressed by the compressor 30 to be liquefied again, and returned to the adsorption tower 10.

On the other hand, the liquid of the polluted substances and water are accumulated in the separation tank 22 having a partition wall 23. Solid substances are deposited as the sludge 20c, and a supernatant liquid (or water layer 20b) is discharged to the outside as treated water. Further, the sludge 20c is collected in a centrifugal apparatus 9 through a valve 7. Next, the sludge 20c is separated into treated water and dehydrated sludge by the centrifugal apparatus 9, and discharged to the outside.

The recycling control of the adsorbent 11 is basically consistent with that of the above-explained water treatment system 100 in the first embodiment. According to the water treatment system 200 in the second embodiment, however, no liquid level sensor is provided in the separation tank 22. Therefore, as different from the water treatment system 100, the valve 6 is opened right after the recycling control of the adsorbent 11 starts, a time of the termination of the recycling control is set based on a change in the discharging flow volume of the water layer 20b measured by the flow volume sensor 8. That is, when the change in the flow volume based on the measured flow volume by the flow volume sensor 8 is equal to or smaller than a predetermined value, it is determined that removal of water and polluted substances from the adsorbent 11 is completed, and thus the recycling control is terminated. Accordingly, such a simple structure may realize the recycling with saving energy.

As explained above, according to the water treatment system 200, the operation control unit 50 calculates a change in water supplied to the separation tank 22 using the flow volume measured by the flow volume sensor 8. That is, in the water treatment system 200, since the valve 6 is fully opened right after the recycling control has been started, the discharging flow volume corresponds to the amount of supplied water. Further, the change in discharging flow volume corresponds to a change in supplied water.

By constructing the water treatment system 200 as explained above, dimethyl ether, water and the polluted substances can be further surely divided well in the separation tank 22. Hence, it becomes possible to more surely prevent dimethyl ether from being discharged to the outside through the valve 6.

### 3. Third Embodiment

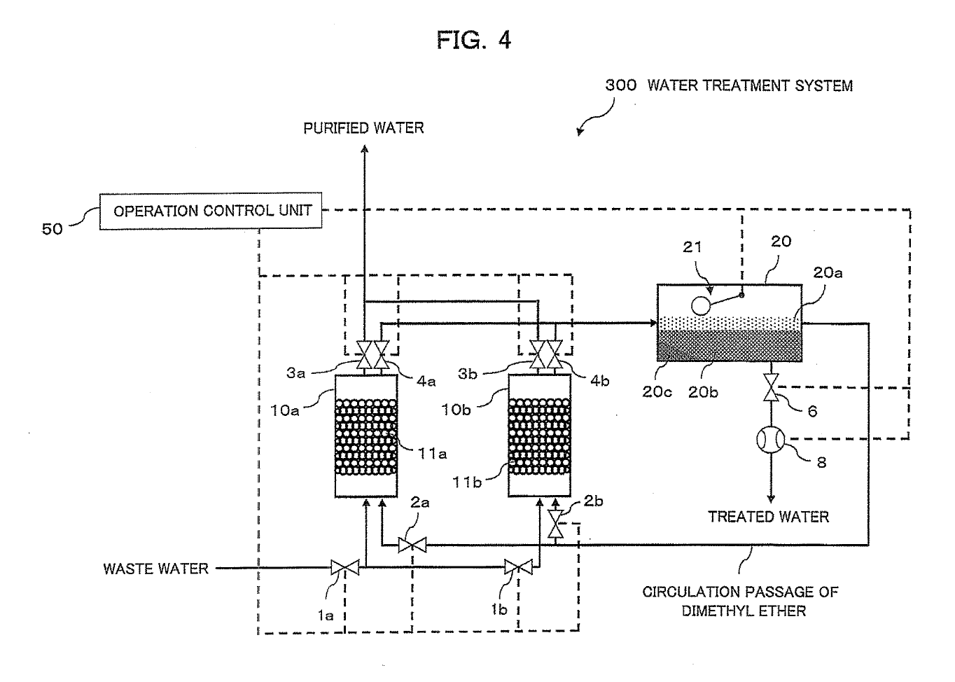

Next, with reference to FIG. 4, an explanation will be given of a water treatment system 300 in a third embodiment. The same component as that of the water treatment system 100 will be denoted by the same reference numeral, and the detailed explanation thereof will be omitted. The water treatment system 300 uses the same basic structure as that of the water treatment system 100, and thus the differences from the above-explained water treatment system 100 will be mainly explained in the following explanation.

FIG. 4 is a schematic diagram illustrating the water treatment system 300 in the third embodiment. In the water treatment system 100 in FIG. 1, only one adsorption tower 10 is connected, while in the water treatment system 300, two adsorption towers 10a and 10b using the same structure as that of the adsorption tower 10 are connected in parallel with the separation tank 20. The adsorption towers 10a and 10b include the same adsorbents 11a and 11b, respectively. In accordance with such a structure, valves 1a, 2a, 3a, 4a, 1b, 2b, 3b, and 4b are provided so as to connect those towers each other like the water treatment system 100. Those valves are controlled by the operation control unit 50.

In the water treatment system 300, the adsorption towers 10a and 10b are connected and provided in a parallel manner. Accordingly, waste water flows through the adsorption tower 10b to allow the adsorbent 11b to adsorb the polluted substances, while at the same time, dimethyl ether flows through the adsorption tower 10a already adsorbing the polluted substances, thereby recycling the adsorbent 11a.

That is, in such a case, for example, the valves 1a and 3a are controlled to be closed and the valves 2a and 4a are controlled to be opened, as the flow control of dimethyl ether to the adsorption tower 10a. Accordingly, no waste water is supplied to the adsorption tower 10a, while only dimethyl ether is supplied thereto. Further, the valves 2b and 4b are controlled to be closed and the valves 1b and 3b are controlled to be opened as the flow control of waste water to the adsorption tower 10b. Hence, no dimethyl ether is supplied to the adsorption tower 10b, while only waste water is supplied thereto. Next, after the recycling of the adsorbent 11a of the adsorption tower 10a is completed, the opening/closing of the valves are changed. Subsequently, waste water is supplied to the adsorption tower 10a, while at the same time, recycling of the adsorbent 11b of the adsorption tower 10b is performed.

As explained above, adsorption and recycling operations both performed simultaneously may reduce a time necessary for water treatment. This allows the water treatment to be conducted in a highly efficient manner. Further, even when, for example, the adsorption tower 10a becomes defective, the water treatment can be continuously conducted using the adsorption tower 10b. Accordingly, stable water treatment is enabled.

### 4. Fourth Embodiment

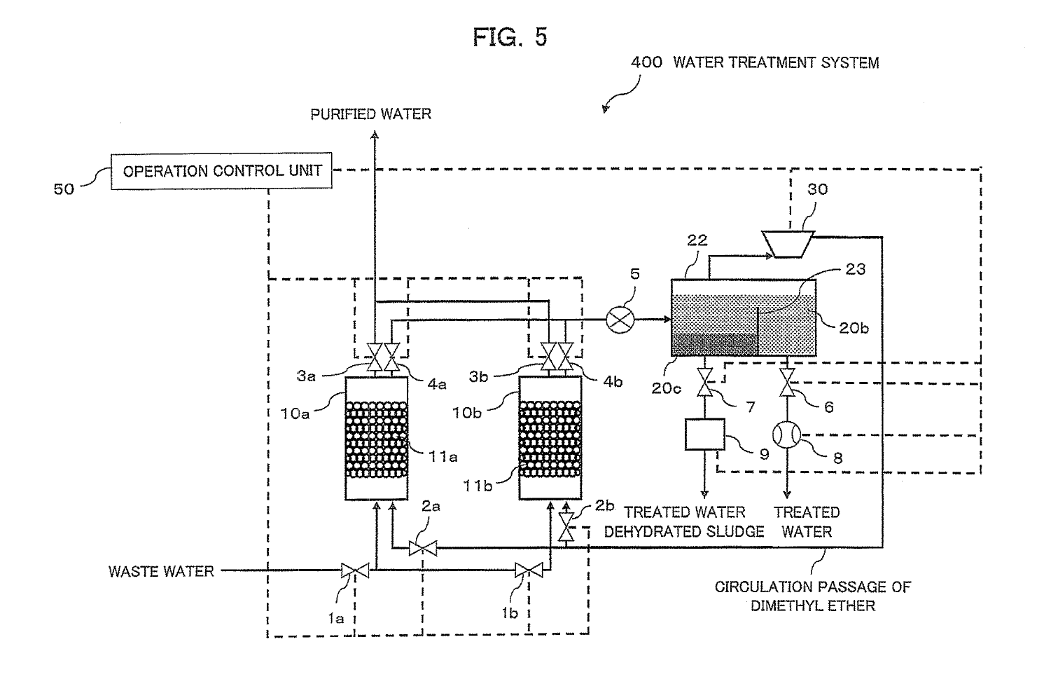

Next, an explanation will be given of a water treatment system 400 in a fourth embodiment with reference to FIG. 5. The same component as those of the water treatment system 200 illustrated in FIG. 3 and the water treatment system 300 illustrated in FIG. 4 will be denoted by the same reference numeral, and the detailed explanation thereof will be omitted. Further, the water treatment system 400 uses the same basic structure as those of the water treatment systems 200 and 300, and the differences from the water treatment systems 200 and 300 will be mainly explained in the following explanation.

In the water treatment system 400, the separation tank 22, etc., illustrated in FIG. 3 are provided, and the adsorption towers 10a and 10b are connected in a parallel manner. Hence, dimethyl ether, water and polluted substances can be further surely separated from each other in the separation tank 22. Accordingly, it becomes possible to further surely prevent dimethyl ether from being discharged to the outside through the valve 6. Moreover, both adsorption and recycling operations conducted simultaneously enables a time necessary for the water treatment to be reduced. Hence, the water treatment can be conducted in a highly efficient manner. Furthermore, even when, for example, the adsorption tower 10a becomes defective, the water treatment can be continuously conducted using the adsorption tower 10b. Accordingly, this realizes a stable water treatment.

### 5. Fifth Embodiment

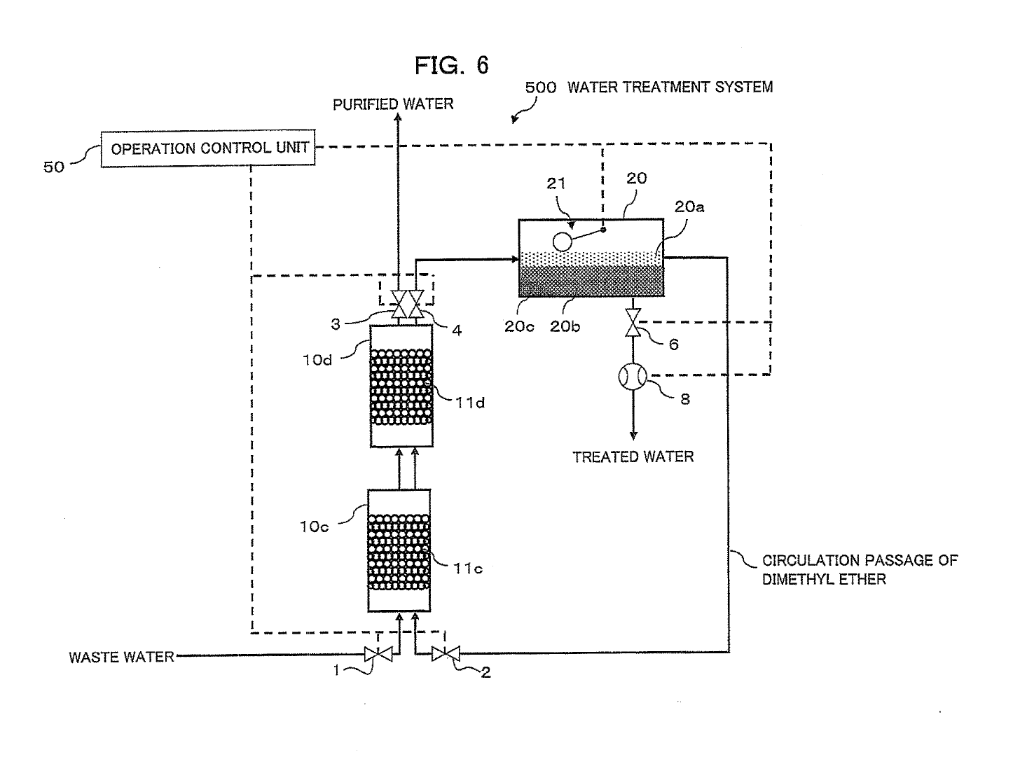

Next, an explanation will be given of a water treatment system 500 in a fifth embodiment with reference to FIG. 6. The same component as that of the water treatment system 100 will be denoted by the same reference numeral, and the detailed explanation thereof will be omitted. Further, since the water treatment system 500 uses the same basic structure as that of the water treatment system 100, the differences from the water treatment system 100 will be mainly explained in the following explanation.

FIG. 6 is a schematic diagram illustrating the water treatment system 500 in the fifth embodiment. The water treatment system 500 has two adsorption towers 10c and 10d connected in series. An adsorbent 11c is filled in the adsorption tower 10c, and an adsorbent 11d is filled in the adsorption tower 10d. According to the water treatment system 500, the adsorbent 11c is, for example, an activated charcoal, while the adsorbent 11d is, for example, aluminum oxide. The adsorbent 11c mainly adsorbs water-soluble organic substances, while aluminum oxide mainly adsorbs heavy metal ions.

Depending on the elements contained in waste water, it is unable to completely carry out a removal through a single adsorption unit (e.g., an activated charcoal, aluminum oxide or zeolite) in some cases. Hence, in order to surely remove the elements contained in waste water, according to the water treatment system 500, two kinds of adsorbents 11c and 11d are utilized. By utilizing multiple kinds of adsorbents in accordance with the elements contained in waste water as explained above, elements in waste water can be further surely adsorbed and removed.

### 6. Sixth Embodiment

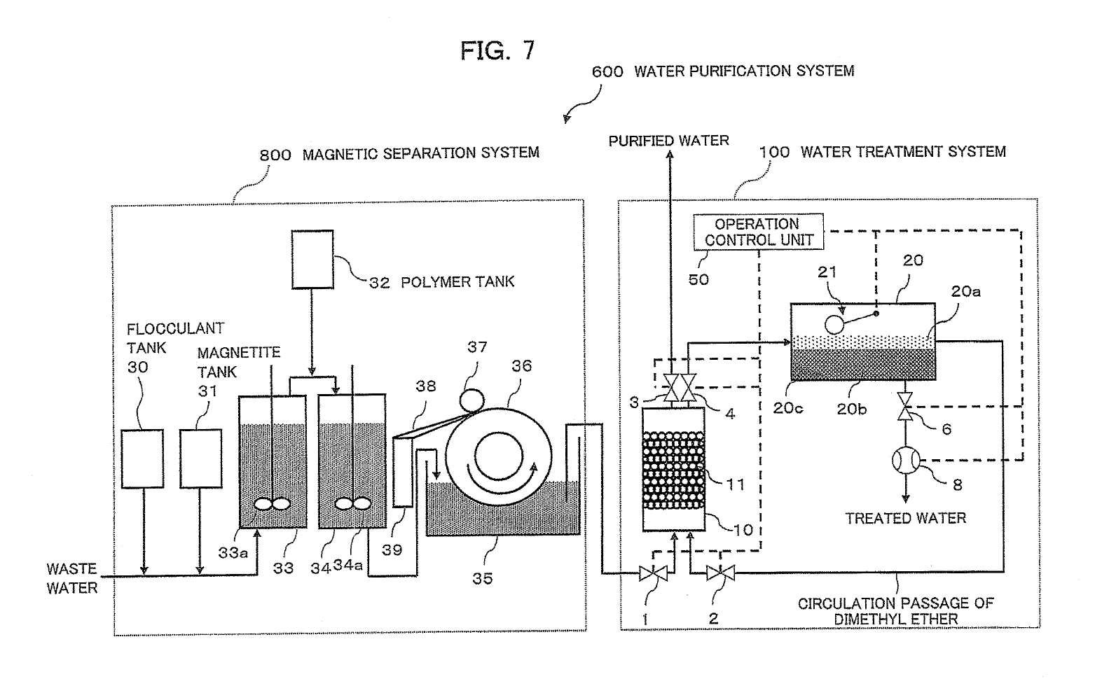

Next, an explanation will be given of a water purification system 600 using the water treatment system 100 in the first embodiment with reference to FIG. 7. The same component as that of the water treatment system 100 illustrated in FIG. 1 will be denoted by the same reference numeral, and the detailed explanation thereof will be omitted. The operation control unit 50 also controls, in addition to the water treatment system 100, the operation of a magnetic separation system 800.

FIG. 7 is a schematic diagram of the water purification system 600 using the water treatment system 100 in the first embodiment. According to the water purification system 600, waste water supplied to the water treatment system 100 is pretreated by the magnetic separation system 800. That is, the magnetic separation system 800 removes the polluted substances from waste water to some degree to purify the waste water, and the water treatment system 100 further purifies that waste water to which the removal operation has been performed.

In the magnetic separation system 800, first, a flocculant tank 30 supplies a flocculant (e.g., poly-aluminum chloride) to waste water. Next, a magnetite tank supplies magnetite (e.g., iron) to the waste water. Furthermore, the mixture of those substances is sufficiently stirred and mixed in a stirring tank 33 by stirring blades 33a. Accordingly, microflocs containing polluted substances in waste water and magnetite, etc., are formed in the stirring tank 33.

To the aqueous solution containing the microflocs thus formed, is added a polymer (e.g., polyglutamic acid or polyalginic acid) from a polymer tank 32. Then, the aqueous solution is sufficiently stirred and mixed in a stirring tank 34 by stirring blades 34a. Accordingly, the microflocs are grown, thereby to form large flocs. Next, the aqueous solution containing the large flocs is supplied to a floc removing tank 35.

The floc removing tank 35 is provided with a hollow magnetic drum 36 with a meshed surface. The surface of the magnetic drum 36 is magnetized, and the lower portion of the magnetic drum 36 is arranged so as to be soaked in a liquid in the floc removing tank 35. Next, as the magnetic drum 36 rotates, the flocs in the liquid containing magnetite are adsorbed on the surface of the magnetic drum 36. The adsorbed flocks are transferred to the upper space of the magnetic drum 36 associated with the rotation of the magnetic drum 36, thereby to contact with a brush roller 37 rotating in the opposite direction to the magnetic drum 36. This allows the flocs to be forcibly scraped from the surface of the magnetic drum 36 by the brush roller 37. Then, the flocks thus scraped are stored in a flock collecting apparatus 39 through a scraper 38.

The waste water from which the polluted substances have been removed as flocks as mentioned hereinbefore is purified to a certain degree. However, some flocks may be left since the floc removing tank 35 is unable to completely remove the flocs in some cases. Further, in other cases, no flocs or no microflocs are formed, letting polluted substances remained in the waste water. In such a case, the water discharged from the magnetic separation system 800 is supplied to the water treatment system 100, enabling the discharged water to be purified more surely and in highly efficient.

The flocs remained as an insufficient removal in the floc removing tank 35 can not be adsorbed by the adsorbent 11 or pass through the pores, thereby to stack in some cases. Here, in such a case, when the adsorbent 11 is recycled by dimethyl ether, such flocs thus remained come to be dissolved in dimethyl ether flowing through the flocs. This allows the stacking flocs not adsorbed or not passing through the pores to be dissolved and removed.

As explained above, according to the purification system 600, the waste water (or aqueous solution) is discharged from the magnetic separation system (or oil/water separation system). Then, the discharged water is to be supplied to the adsorption tower 10 (or adsorption unit) of the water treatment system 100. By carrying out the separation twice in this manner, the polluted substances are more surely removed from the waste water.

### 7. Seventh Embodiment

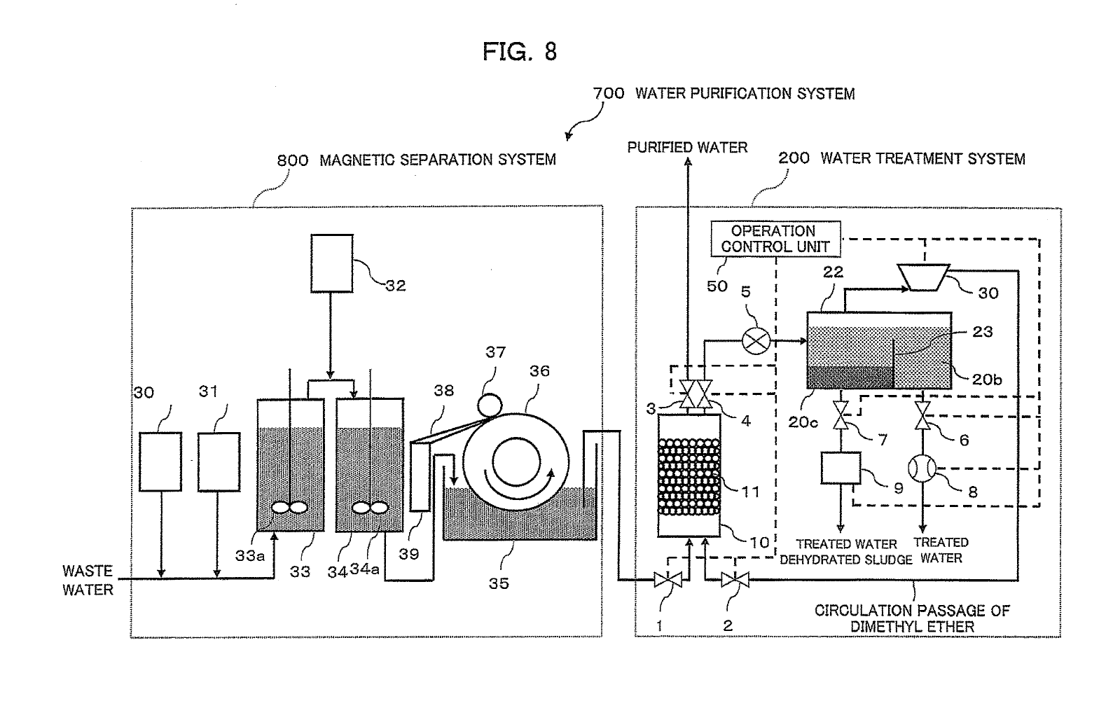

Next, an explanation will be given of a water purification system 700 including the water treatment system 200 in the second embodiment with reference to FIG. 8. The same component as those of the water treatment system 200 illustrated in FIG. 3 and the magnetic separation system 800 illustrated in FIG. 7 will be denoted by the same reference numeral. The detailed explanation thereof will be omitted.

FIG. 8 is a schematic diagram of the water purification system 800 including the water treatment system 200 in the second embodiment. The water treatment system 200 uses the same basic structure as that of the water purification system 600 as explained with reference to FIG. 7. However, in the water purification system 700, the water treatment system 200 is provided instead of the water treatment system 100 of the water purification system 600. Even though the water purification system is constructed as mentioned above, heavy metals, etc., in waste water are surely and efficiently removed.

### 8. Modified Examples

Hereinbefore, the respective embodiments have been explained with reference to the drawings. Herein, it should be noted that the embodiments of the present invention are not limited to the illustrated examples. Hence, any unit may be, for example, added, deleted, or replaced arbitrary with respect to the illustrated examples without departing from the scope and spirit of the present invention.

Some of the structures of the respective embodiments may be combined together. More specifically, for example, the water treatment system 100 may be provided with the scattering valve 5 of the water treatment system 200. Further, for example, the water treatment system 200 may be provided with the liquid level sensor 21 of the water treatment system 100. Moreover, the separation tank 22 (three-layer separation tank) of the water treatment system 200 may be applied to the water treatment system 100. Furthermore, a flow volume sensor may be provided in the halfway of the circulation passage of dimethyl ether between the adsorption tower 10 and the separation tank 20 to measure a change in the flow volume.

The separation unit is not limited to the illustrated examples, and any arbitrary units are applicable. For example, a three-phase separation tank (or separator) may be utilized as the separation tank 22 with the partition wall 23 in the example illustrated in FIG. 3. However, any unit is applicable as far as such a unit can separate vaporized dimethyl ether. Further, in order to facilitate dimethyl ether to be vaporized, a heater may be equipped with the separation tank 22 so as to heat a supplied liquid. That is, the vaporizing unit for vaporizing dimethyl ether is not limited to the scattering valve. Moreover, the liquefying unit that liquefies dimethyl ether is not limited to the compressor, and may be, for example, a cooler.

Further, the two adsorption towers are provided in the cases of, for example, FIG. 4 and FIG. 6, while three or more adsorption towers may be provided. Moreover, in the illustrated examples, a single separation tank is provided, while multiple separation tanks may be provided for the separation process.

Furthermore, in the respective embodiments as explained above, for example, dimethyl ether is utilized as a medium for removing the polluted substances. However, it should be noted that such a medium is not limited to dimethyl ether. That is, any media are applicable as far as the media enable the polluted substances adsorbed by the adsorbent 11 to be, for example, dissolved or mixed therein to remove the polluted substances, and the media are separable in the separation tanks 20 and 22. More specifically, such media applicable include, in addition to dimethyl ether, ethers such as diethyl ether, and methyl ethyl ether; ketones such as acetone, and methyl ethyl ketone; alcohols such as methanol, ethanol, propanol, butanol, pentanol, and hexanol; and aldehydes such as formaldehyde, and acetaldehyde, and chloroform or the like. Those media may be used in a mixed manner as needed. Moreover, when, for example, ketones or alcohols are utilized as media, waste water and the media are separable based on the difference in the boiling points.

However, among those media, in the first embodiment illustrated in FIG. 1, for example, it is preferable to use a medium that separates into two layers in the separation tank 20. More specifically, application of ethers such as dimethyl ether, diethyl ether, and methyl ethyl ether, is preferable. On the other hand, in the second embodiment illustrated in FIG. 3, for example, it is preferable to apply a medium that turns to gas at 25° C. and 101 kPa. More specifically, application of ethers such as dimethyl ether, diethyl ether, and methyl-ethyl ether, is preferable.

The kind and filled amount of the adsorbent 11 can be set arbitrary in accordance with the kind and amount of polluted substances. Exemplary adsorbents 11 include an activated charcoal, aluminum oxide, and zeolite, and can be used in a combined manner as needed. Note the structure of the adsorption unit is not limited to an adsorption tower, and an arbitrary structure can be used. Further, the oil/water separation system that separates an oil and water from each other is not limited to the magnetic separation system. Hereby, oil and water can be separated through any arbitrary techniques.

In the above mentioned examples, substances adsorbed by the adsorbent include water soluble organic substances and heavy metal ions. However, such substances are not limited to those examples. Although the target to be adsorbed by the adsorbent is not limited, it is preferable that such a target should be at least one of water soluble organic substances and metal elements. A form of metal element is not limited to the exemplified heavy metal ion, and may include a simple substance, a compound and a complex thereof, etc. Further, such a metal may be a metal other than a heavy metal. Herein, a form of the metal may also include an elemental substance, a compound and a complex thereof, etc.

### EXPLANATION OF REFERENCES

10: Adsorption Tower (or Adsorption Unit)
11: Adsorbent
20: Separation Tank (or Separation Unit)
21: Liquid Level Sensor
22: Separation Tank (or Separation Unit)
30: Compressor (or Liquefying Unit)
50: Operation Control Unit
100: Water Treatment System
200: Water Treatment System
300: Water Treatment System
400: Water Treatment System
500: Water Treatment System
600: Water Treatment System
700: Water Treatment System
800: Magnetic Separation System (or Oil/Water Separation System)

1. A water treatment system comprising:
an adsorption unit provided with an adsorbent of adsorbing a target in an aqueous solution which is supplied to the adsorption unit;
a separation unit supplied with the target removed from the adsorbent via contact with a medium, water and the medium having contacted with the adsorbent, and separating the medium from a mixture of the supplied water, medium and target;
a circulation passage connecting the adsorption unit with the separation unit such that a circulation unit circulates the medium to be in contact with the adsorbent between the adsorption unit and the separation unit; and
an operation control unit controlling a flow of the medium in accordance with a change in an water amount supplied to the separation unit, wherein the change is caused by the successive contact of the medium with the adsorbent during the circulation thereof in the passage.

2. The water treatment system according to claim 1, further comprising a liquid level sensor measuring a liquid level of a liquid in the separation unit,
wherein the operation control unit calculates a change in the water amount supplied to the separation unit based on the liquid level measured by the liquid level sensor.

3. The water treatment system according to claim 1, further comprising a flow volume sensor measuring a flow volume of a discharged liquid when the liquid stored in the separation unit is discharged to an outside,
wherein the operation control unit calculates a change in the water amount supplied to the separation unit based on the flow volume measured by the flow volume sensor.

4. The water treatment system according to claim 1, wherein the separation unit is a three-layer separation tank of separating the mixture into a gas layer, a liquid layer, and a solid layer.

5. The water treatment system according to claim 1, wherein
a vaporization unit vaporizing the flowing medium is provided in a halfway of the circulation passage arranged from the adsorption unit to the separation unit, and
a liquefying unit that liquefies the flowing medium is provided in a halfway of the circulation passage arranged from the separation unit to the adsorption unit.

6. The water treatment system according to claim 1, wherein the target is at least one substance selected from a water-soluble organic substance and a metal element.

7. The water treatment system according to claim 1, wherein the adsorbent is one or more kinds of materials selected from a group of activated charcoal, aluminum oxide and zeolite.

8. The water treatment system according to claim 1, wherein the medium is composed of ethers.

9. The water treatment system according to claim 1, wherein the aqueous solution supplied to the adsorption unit is water discharged from an oil/water separation system.

10. The water treatment system according to claim 1, wherein a plurality of the adsorption units are provided.
